(19) United States
(12) Patent Application Publication
(10) Pub. No.: US 2001/0046621 A1
(43) Pub. Date: Nov. 29, 2001

(54) Terminal saver

(76) Inventor: Richard Colli JR., Yuba City, CA (US)

Correspondence Address: Matthew J. Peirce, Esq., 1550 Starlight Canyon Avenue, Las Vegas, NV, 89123, US

(21) Appl. No.: 09/864,418

(22) Filed: May 23, 2001

Related U.S. Application Data
(60) Provisional application No. 60/206,309, filed on May 23, 2000.

(51) Int. Cl. H01M 2/00

(52) U.S. Cl. 429/65

(57) ABSTRACT

A new and improved apparatus is disclosed which is designed to reduce and/or prevent corrosion that occurs on a battery post and battery terminal of an automobile or other type of object that uses a battery in order to properly function. The present invention would have two preferred embodiments termed a “top post” and a “side post,” with the top post being L-shaped. The top post embodiment would be fabricated from two bars of conductive metal, with the second bar fixedly attached to the first bar at a ninety-degree angle. The side post embodiment would be in the shape of a washer, with the outside diameter of the side post being approximately ½″, and the inside diameter of the hole within the side post is approximately 11/32″. The top post embodiment would be designed for use with battery posts that would be top-mounted on a battery, while the side post embodiment would be designed for use with battery posts that would be side-mounted on a battery.

### BACKGROUND OF THE INVENTION

The present invention concerns that of a new and improved apparatus for reducing and/or preventing corrosion that occurs on a battery post and battery terminal of an automobile or other type of object that uses a battery in order to properly function.

### DESCRIPTION OF THE PRIOR ART

U.S. Pat. No. 5,888,663, issued to Frazier et al., discloses a long-life battery which as an acid-based heat source and a magnetic field source to improve the efficiency and life of the battery's ability to deliver an electrical charge.

U.S. Pat. No. 4,286,027, issued to Shropshire et al., discloses monopolar battery performance which may be enhanced by circulating the electrolyte.

U.S. Pat. No. 3,987,240, issued to Schultz, discloses a direct current power supply system for providing power, including standby, to coaxial cable amplifiers in community antenna television networks.

### SUMMARY OF THE INVENTION

The present invention concerns that of a new and improved apparatus for reducing and/or preventing corrosion that occurs on a battery post and battery terminal of an automobile or other type of object that uses a battery in order to properly function. The present invention would have a preferable embodiment either as a top post or a side post, with the top post being L-shaped. The top post would be fabricated from two bars of conductive metal, with the upper piece of the top post being approximately ⅜″ long, while the side piece of the top post would be approximately 7/16″ long. Both the upper piece and the side piece of the top post would be approximately 0.030 inches in width and 0.030 inches in depth. The upper piece and side piece of the top post would each have a first end and a second end, with the second end of the side piece being fused to the second end of the upper piece of the present invention at a 90 degree angle. The side post of the present invention is in the shape of a washer, with the outside diameter of the side post being approximately ½″, and the inside diameter of the hole within the side post is approximately 11/32″.

Although the top post and side posts are shown in this provisional patent in specific shapes, the shapes shown are not crucial to the proper functioning of the present invention. Alternative shapes of the top post and the side post of the present invention can be utilized, as long as these alternative shapes would properly conduct electricity between a battery post and a battery terminal and not leak electricity or otherwise provide a short circuit.

There has thus been outlined, rather broadly, the more important features of a battery terminal protector in order that the detailed description thereof that follows may be better understood and in order that the present contribution to the art may be better appreciated. There are, of course, additional features of the battery terminal protector that will be described hereinafter and which will form the subject matter of the claims appended hereto.

In this respect, before explaining at least one embodiment of the battery terminal protector in detail, it is to be understood that the battery terminal protector is not limited in its application to the details of construction and to the arrangements of the components set forth in the following description or illustrated in the drawings. The battery terminal protector is capable of other embodiments and being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present battery terminal protector. It is important, therefore, that the claims be regard as including such equivalent constructions insofar as they do not depart from the spirit and scope of the present invention.

It is therefore an object of the present invention to provide a battery terminal protector which has all of the advantages of the prior art and none of the disadvantages.

It is another object of the present invention to provide a battery terminal protector which may be easily and efficiently manufactured and marketed.

It is another object of the present invention to provide a battery terminal protector which is of durable and reliable construction.

It is yet another object of the present invention to provide a battery terminal protector which is economically affordable and available for the public.

Other objects, features and advantages of the present invention will become more readily apparent from the following detailed description of the preferred embodiment when considered with the attached drawings and appended claims.

### BRIEF DESCRIPTION OF THE DRAWINGS

FIG. 1 shows a side view of the present invention designed as a top post.

FIG. 2 shows a front view of the present invention designed as a top post.

FIG. 3 shows a perspective view of the present invention designed as a side post.

FIG. 4 shows a top view of the present invention designed as a side post.

FIG. 5 shows a top view of an alternative embodiment of the present invention.

FIG. 6 shows a side view of an alternative embodiment of the present invention.

FIG. 7 shows a front view of an alternative embodiment of the present invention.

### DESCRIPTION OF THE PREFERRED EMBODIMENT

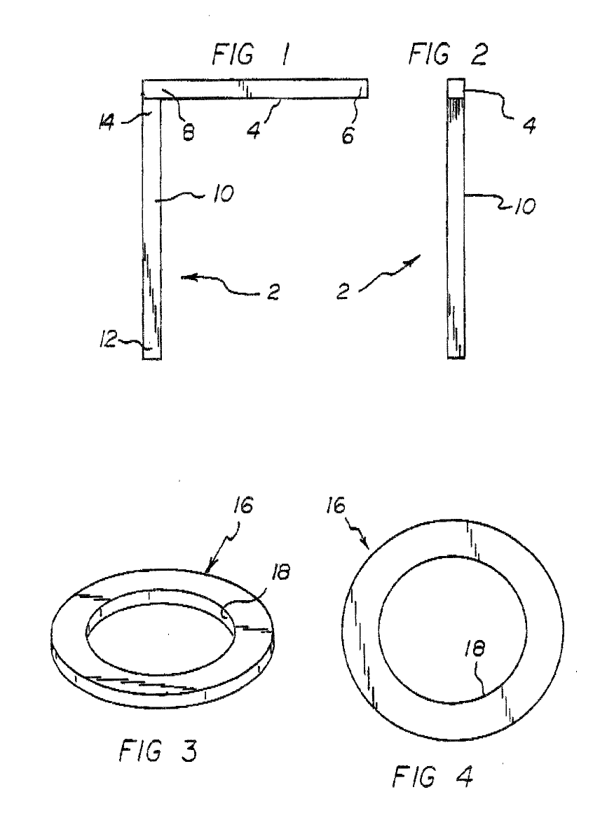

FIGS. 1 and 2 show a side view and front view, respectively, of the present invention designed as a top post 2. Top post 2 is L-shaped and is comprised of two bars of conductive metal, upper piece 4 and side piece 10. Upper piece 4 of top post 2 would be approximately ⅜″ long, while side piece 10 of top post 2 would be approximately 7/16″ long. Both upper piece 4 and side piece 10 of top post 2 would be approximately 0.30 inches in width and 0.030 inches in thickness.

Upper piece 4 of top post 2 would have a first end 6 and a second end 8, while side piece 10 would have a first end 12 and a second end 14. Second end 14 of side piece 10 would be fused to second end 8 of upper piece 4 of the present invention at a 90 degree angle.

Top post 2 is to be used as a bridge between a battery post and a battery terminal. If a battery would include two battery posts, then two top posts 2 would be used. Using top post 2 as a “bridge” between a battery post and a battery terminal will significantly cut down or prevent corrosion on the battery post and/or battery terminal by allowing the corrosion to instead accumulate on top post 2 rather than accumulate on a battery post and/or battery terminal, thereby extending the life of the battery and saving money and time for a consumer.

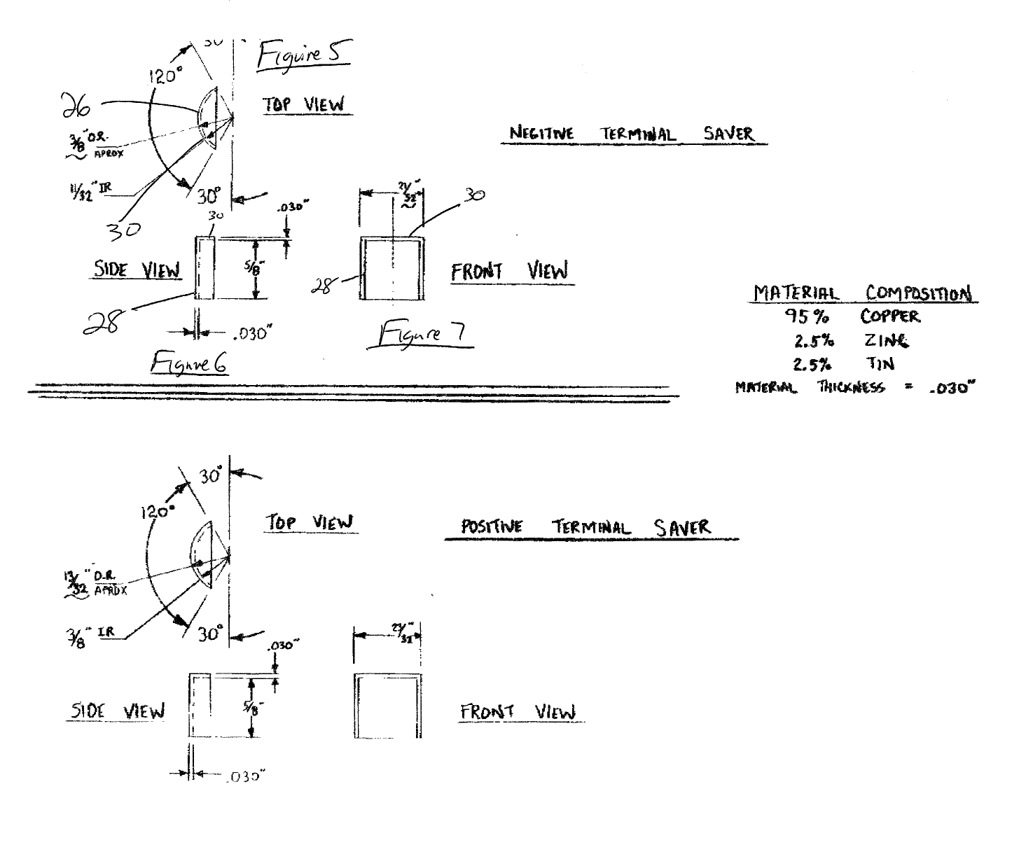

FIGS. 3 and 4 show perspective and top views, respectively, of the present invention as a side post 16. Side post 16 of the present invention is in the shape of a washer, with the outside diameter of side post 16 being approximately ½″, and the inside diameter of hole 18 within the side post being approximately 11/32″. The thickness of side post 16 is approximately 0.030 inches.

Side post 16 is to be used as a bridge between a battery post and a battery terminal. If a battery would include two battery posts, then two side posts 16 would be used. Using side post 16 as a “bridge” between a battery post and a battery terminal will significantly cut down or prevent rust on the battery post and/or battery terminal by allowing the rust to instead accumulate on side post 16.

Although the present invention as two preferred embodiments as evidenced in this application in the shapes of top post 2 and side post 16, the shapes shown are not crucial to the proper functioning of the present invention. Alternative shapes of top post 2 and side post 16 of the present invention can be utilized, as long as these alternative shapes would properly conduct electricity between a battery post and a battery terminal and not leak electricity or otherwise provide a short circuit.

FIGS. 5, 6, and 7 show top, side, and front views of the alternative embodiment 26 of the present invention. In this embodiment, the present invention would have a base 28 and a top portion 30. Base 28 would bent into a semi-circular shape to approximately 120 degrees and would have top portion 30 attached to the top of it. Top portion 30 would be a flat surface. Alternative embodiment would preferably be fabricated from 95% copper, 2.5% zinc, and 2.5% tin. The thickness of the composition used to make alternative embodiment 26 would be 0.030 inch.

Alternative embodiment 26 could be used either with a negative terminal or a positive terminal. With a negative terminal, alternative embodiment 26 would have an outer diameter of approximately ⅜ inch, an inner diameter of approximately 11/32 of an inch, and a height of approximately ⅝ inch. With a positive terminal, alternative embodiment 26 would have an outer diameter of approximately 13/32 inch, an inner diameter of approximately ⅜ of an inch, and a height of approximately ⅝ inch.

What I claim as my invention is:

1. An apparatus for reducing corrosion on a battery terminal comprising
(a) a first piece of conducting material, the first piece having two ends, a first end and a second end,
(b) a second piece of conducting material, the second piece having two ends, a first end and a second end,
(c) wherein the first piece of conducting material or the second piece of conducting material would be placed against a battery terminal.

2. An apparatus for reducing corrosion on a battery terminal according to claim 1 wherein the apparatus further comprises:
(a) a first piece of conducting material, the first piece having two ends, a first end and a second end, the first piece being approximately ⅜ inch in length, the first piece being approximately 0.30 inches in width and 0.030 inches in thickness, and
(b) a second piece of conducting material, the second piece having two ends, a first end and a second end, the second end of the second piece of conducting material being fixedly attached to the second end of the first piece at approximately a ninety-degree angle, the second piece being approximately 7/16 inch in length, the second piece being approximately 0.30 inches in width and 0.030 inches in thickness,
(c) wherein the first piece of conducting material or the second piece of conducting material would be placed against a battery terminal.

3. An apparatus for reducing corrosion on a battery terminal according to claim 2 in combination with:
(a) a battery terminal placed in direct contact with the apparatus, and
(b) a battery post placed in direct contact with the apparatus, the battery post not being in direct contact with the battery terminal.

4. An apparatus for reducing corrosion on a battery terminal comprising a piece of conducting material, the piece of conducting material designed in the shape of a washer, the washer having a central hole, the outer diameter of the washer being approximately ½ inch, the diameter of the central hole on the washer being approximately 11/32 inch, the apparatus having a diameter of approximately 0.03 inch.

5. An apparatus for reducing corrosion on a battery terminal according to claim 4 in combination with:
(a) a battery terminal placed in direct contact with the apparatus, and
(b) a battery post placed in direct contact with the apparatus, the battery post not being in direct contact with the battery terminal.

6. An apparatus for reducing corrosion on a battery terminal comprising:
(a) a first piece of conducting material, the first piece acting as a base, the base being bent into a semicircular shape, the base being approximately ⅝ of an inch in height, the first piece of conducting material having a top and a bottom,
(b) a second piece of conducting material, the second piece acting as a top surface, the second piece connected to the top of the first piece of conducting material, the second piece being a flat surface,
(c) wherein the second piece of conducting material would be placed against a battery terminal.

7. An apparatus for reducing corrosion on a battery terminal according to claim 5 wherein the apparatus would preferably be used for a negative terminal, and further wherein the first piece of conducting material would have an inner diameter of approximately 11/32 of an inch and an outer diameter of approximately ⅜ of an inch.

8. An apparatus for reducing corrosion on a battery terminal according to claim 5 wherein the apparatus would preferably be used for a positive terminal, and further wherein the first piece of conducting material would have an inner diameter of approximately ⅜ of an inch and an outer diameter of approximately 13/32 of an inch.

9. An apparatus for reducing corrosion on a battery terminal according to claim 5 wherein the first piece of conducting material and the second piece of conducting material would preferably be fabricated from 95% copper, 2.5% zinc, and 2.5% tin.
